(19) United States
(12) Patent Application Publication
(10) Pub. No.: US 2025/0075662 A1
(43) Pub. Date: Mar. 6, 2025

(54) Turbine Engine having First and Second Accessory Gearboxes

(71) Applicant: GENERAL ELECTRIC COMPANY, Schenectady, NY (US)

(72) Inventors: John Carl Glessner, Kings Mills, OH (US); Stephen G. Matava, Andover, MA (US)

(21) Appl. No.: 18/461,078

(22) Filed: Sep. 5, 2023

(51) Int. Cl. F02C 7/32; F02C 3/06

(52) U.S. Cl. CPC F02C 7/32; F05D 2240/14; F05D 2260/4031

(57) ABSTRACT

A turbine engine having an inner cowl that circumscribes at least a portion of an engine core, where the inner cowl is radially spaced from the engine core to define an inner cowl space. An outer cowl circumscribes at least a portion of the inner cowl where the outer cowl includes a radially outer surface spaced from a radially inner surface to define an outer cowl space. A fairing extends radially between the inner cowl and the outer cowl. A first accessory gearbox is located in the inner cowl space and the fairing. A second accessory gearbox is located in the outer cowl space and operably couples to the first accessory gearbox.

### TECHNICAL FIELD

This disclosure relates to a turbine engine, and more specifically, to a turbine engine including a first accessory gearbox and a second accessory gearbox.

### BACKGROUND

Gas turbine engines often include an accessory gearbox to power or drive accessory systems such as fuel pumps, lubrication pumps, air compressors, scavenge pumps, electrical generators, hydraulic pumps, etc. The accessory gearbox can be driven by one or more components of the gas turbine engine. The accessory systems can require a power output having characteristics (rotational speed, torque, horsepower, etc.) that is different from that provided by the gas turbine engine. The accessory gearbox provides an interface that converts the power supplied by the gas turbine engine to something usable by the accessory systems.

### BRIEF DESCRIPTION OF THE DRAWINGS

A full and enabling disclosure, including the best mode thereof, directed to one of ordinary skill in the art, is set forth in the specification, which refers to the appended figures in which:

In the drawings:

FIG. 1 is a schematic view of a turbine engine with a dual sectional cutaway along a turbine engine axis of rotation illustrating a first accessory gearbox and a second accessory gearbox, according to aspects of the present disclosure.

FIG. 2 is a side view of the selected components of the turbine engine of FIG. 1, further illustrating the first accessory gearbox and the second accessory gearbox, according to aspects of the present disclosure.

FIG. 3 is a schematic cross-sectional view taken along line III-III of FIG. 1, according to aspects of the present disclosure.

FIG. 4 is a variation of the schematic cross-sectional view of FIG. 3, according to aspects of the present disclosure.

### DETAILED DESCRIPTION

Traditionally, accessories are located in the outer cowl space with an accessory gearbox. However, locating the accessories and the accessory gearbox in the outer cowl changes the aerodynamic line of the outer cowl. That is, the accessories and the accessory gearbox increase thickness of the outer cowl and can even result in a bulge or protrusion in the outer cowl.

Moving the first and second accessories out of the outer cowl and into another part of the engine requires multiple gearboxes. The added weight of multiple gearboxes has traditionally discouraged the use of multiple gearboxes as an increase in weight traditionally results in a decrease of overall turbine engine fuel efficiency.

This disclosure, however, illustrates a solution that moves the first accessory and the second accessory out of the outer cowl, while including a first accessory gearbox and a second accessory gearbox in a unique configuration where little to no weight is added, and simultaneously improving the aerodynamics of the outer cowl and the overall turbine engine fuel efficiency increases.

One or more aspects described herein provide a first accessory gearbox (AGB1) and a second accessory gearbox (AGB2) within a turbine engine. The turbine engine includes a fan section, a compressor section, a combustion section, and a turbine section in axial flow arrangement. The compressor section comprises a low-pressure compressor and a high-pressure compressor. An inner cowl circumscribes at least a portion of an engine core and is radially spaced from the engine core to define an inner cowl space. An outer cowl circumscribes at least a portion of the inner cowl, where a fairing extends between the inner cowl and the outer cowl having at least a hollow portion.

The AGB1 is located in the inner cowl space and extends into the hollow portion of the fairing. Optionally, the AGB1 extends through the fairing from the inner cowl space into the outer cowl. A first accessory device located in the inner cowl space is operably coupled to the AGB1. A second accessory device located in the hollow portion of the fairing is also operably coupled to the AGB1.

The AGB2 is located in the outer cowl is operably coupled to and spaced from the first accessory gearbox. A third accessory device is operably coupled to the second accessory gearbox and located in the outer cowl.

For purposes of illustration, the present disclosure will be described with respect to a turbine engine for an aircraft. More specifically, a ducted turbofan. The ducted turbofan can be direct drive or geared. Further, the disclosure can have applicability in a variety of vehicles or engines, and can be used to provide benefits in industrial, commercial, and residential applications. Further non-limiting examples of other vehicles or engines to which the disclosure can relate can include boats, helicopters, cars, or other aquatic, air, space, or land vehicles. Industrial, commercial, or residential applications of the disclosure can include, but are not limited to, marine power plants, wind turbines, or small power plants.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

As used herein, the term “upstream” refers to a direction that is opposite the fluid flow direction, and the term “downstream” refers to a direction that is in the same direction as the fluid flow. The term “fore” or “forward” means in front of something and “aft” or “rearward” means behind something. For example, when used in terms of fluid flow, fore/forward can mean upstream and aft/rearward can mean downstream.

Additionally, as used herein, the terms “radial” or “radially” refer to a direction away from a common center. For example, in the overall context of a turbine engine, radial refers to a direction along a ray extending between a center longitudinal axis of the engine (turbine engine axis of rotation) and an outer engine circumference.

Furthermore, as used herein, the term “set” or a “set” of elements can be any number of elements, including only one.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, connected, and joined) are to be construed broadly and can include intermediate structural elements between a collection of elements and relative movement between elements unless otherwise indicated. As such, connection references do not necessarily infer that two elements are directly connected and in fixed relation to one another.

The drawings are for purposes of illustration only and the dimensions, positions, order and relative sizes reflected in the drawings attached hereto can vary.

As used herein, the term “accessory gearbox (AGB)” refers to a gearbox that receives rotational input from a rotating shaft in the engine core of a turbine engine or another gearbox. The AGB provides an output to accessories such as, but not limited to, engine accessories or aircraft accessories. In other words, an AGB provides output to at least one accessory and can optionally provide a rotational output to a second AGB.

A used herein, the term “transfer gear box (TGB)” is a gearbox that provides rotational output to at least another gearbox.

As used herein, the term “aircraft accessory” refers to an accessory that can interface with components outside of the turbine engine 10, once the turbine engine 10 is self-sustaining. Optionally, aircraft accessory can contribute to the operation of the turbine engine 10 in addition to interfacing with one or more components outside of the turbine engine 10. Non-limiting examples of aircraft accessories include an electrical generator, a hydraulic pump, an aircraft permanent magnet alternator, or an air turbine starter. Further non-limiting examples can include a primary lubrication pump, secondary lubrication pump, main fuel pump, fuel boost pump, or rotisserie.

As used herein, the term “engine accessory” refers to an accessory that only contributes to the operation of the turbine engine 10. Non-limiting examples of engine accessories include a fuel pump, main fuel pump, fuel boost pump, lubrication pump, primary lubrication pump, secondary lubrication pump, air compressor, starter, air turbine starter, scavenge pump, fuel control, rotisserie, or permanent magnet alternator.

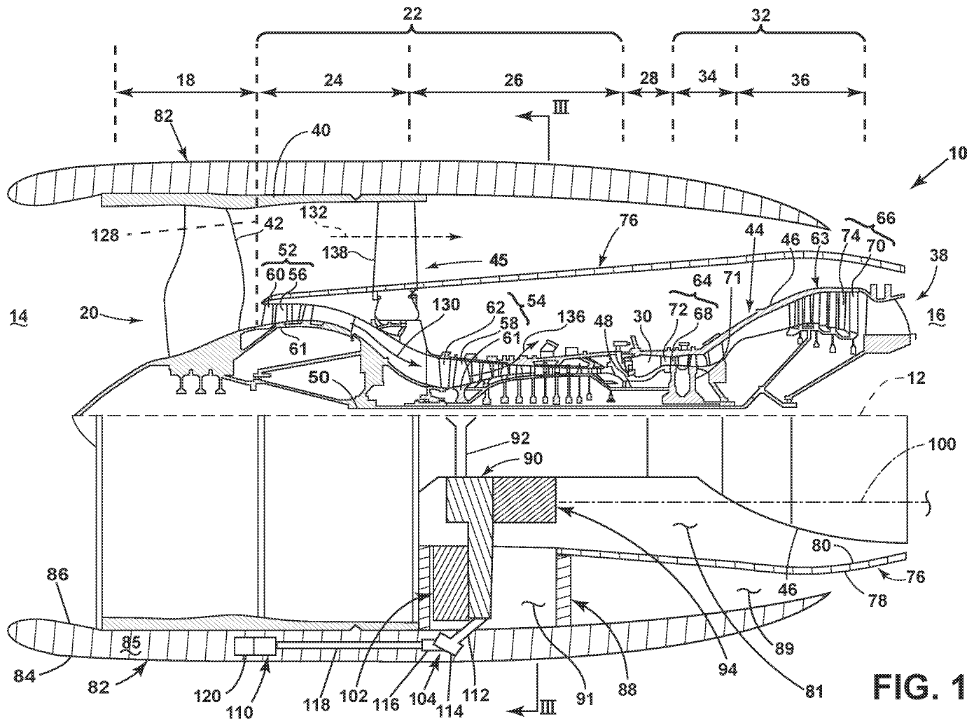

FIG. 1 is a schematic partial section view of a turbine engine 10 for an aircraft, where an upper section of FIG. 1 illustrates the cross section of the turbine engine 10 and a lower section illustrates a schematic of static support structures, an accessory gearbox, a transfer gearbox, accessory devices, and a connection assembly that couples the accessory gearbox to the transfer gearbox.

The turbine engine 10 has a centerline or turbine engine axis of rotation 12 extending forward 14 to aft 16. The turbine engine 10 includes, in axial flow arrangement, a fan section 18 including a fan assembly 20, a compressor section 22 including a booster or a low-pressure (LP) compressor 24 and a high-pressure (HP) compressor 26, a combustion section 28 including a combustor 30, a turbine section 32 including an HP turbine 34, and an LP turbine 36, and an exhaust section 38.

The fan section 18 includes a fan casing 40 surrounding the fan assembly 20. The fan assembly 20 includes a plurality of fan blades 42 disposed radially about the turbine engine axis of rotation 12. The compressor section 22, the combustor 30, and the turbine section 32 form a core illustrated as an engine core 44, which generates combustion gases. The engine core 44 is surrounded by a core casing 46, which can be coupled with the fan casing 40.

An outlet guide vane assembly 45 is located downstream of the fan blades 42. The outlet guide vane assembly 45 can be located in the fan section 18, the LP compressor 24, or axially span a portion of the fan section 18 and a portion of the LP compressor 24.

An HP shaft or HP spool 48 disposed coaxially about the turbine engine axis of rotation 12 of the turbine engine 10 drivingly connects the HP turbine 34 to the HP compressor 26. An LP shaft or LP spool 50, which is disposed coaxially about the turbine engine axis of rotation 12 of the turbine engine 10 within the larger diameter annular HP spool 48, drivingly connects the LP turbine 36 to the LP compressor 24 and fan assembly 20. The HP spool 48 and LP spool 50 are rotatable about the turbine engine axis of rotation 12 and couple to a plurality of rotatable elements, which can collectively define an inner rotor/stator. While illustrated as a rotor, it is contemplated that the inner rotor/stator can be a stator.

The LP compressor 24 and the HP compressor 26 respectively include a plurality of compressor stages 52, 54, in which a set of compressor blades 56, 58 rotate relative to a corresponding set of static compressor vanes 60, 62, which can also be called a nozzle, to compress or pressurize the stream of fluid passing through the stage. In a single compressor stage 52, 54, multiple compressor blades 56, 58 can be provided in a ring and can extend radially outwardly relative to the turbine engine axis of rotation 12, from a blade platform to a blade tip, while the corresponding static compressor vanes 60, 62 are positioned upstream of and adjacent to the rotating compressor blades 56, 58. It is noted that the number of blades, vanes, and compressor stages shown in FIG. 1 were selected for illustrative purposes only, and that other numbers are possible.

The compressor blades 56, 58 for a stage of the compressor can be mounted to a disk 61, which is mounted to the corresponding one of the HP spool 48 and LP spool 50, with each stage having its own disk 61. The vanes 60, 62 for a stage of the compressor section 22 can be mounted to the core casing 46 in a circumferential arrangement.

The HP turbine 34 and the LP turbine 36, respectively, include a plurality of turbine stages 64, 66, in which a set of turbine blades 68, 70 are rotated relative to a corresponding set of static turbine vanes 72, 74, which can also be called a nozzle, to extract energy from the stream of fluid passing through the stage. In a single turbine stage 64, 66, multiple turbine blades 68, 70 can be provided in a ring and can extend radially outwardly relative to the turbine engine axis of rotation 12, from a blade platform to a blade tip, while the corresponding static turbine vanes 72, 74 are positioned upstream of and adjacent to the rotating turbine blades 68, 70. It is noted that the number of blades, vanes, and turbine stages shown in FIG. 1 were selected for illustrative purposes only, and that other numbers are possible.

The turbine blades 68, 70 for a stage of the turbine section 32 can be mounted to a disk 71, which is mounted to the corresponding one of the HP spool 48 and LP spool, 50, with each stage having a dedicated disk 71. The turbine vanes 72, 74 for a stage of the turbine section 32 can be mounted to the core casing 46 in a circumferential arrangement.

Complementary to the rotor portion, the stationary portions of the turbine engine 10, such as the static compressor vanes 60, 62, and the static turbine vanes 72, 74 among the compressor and turbine sections 22, 32 are also referred to individually or collectively as a stator 63. As such, the stator 63 can refer to the combination of non-rotating elements throughout the turbine engine 10.

An inner cowl 76 is radially spaced from the engine core 44 and can circumscribe at least a portion of the engine core 44. The inner cowl 76 can include an outside face 78 and an inside face 80, where the inside face 80 of the inner cowl 76 can confront the engine core 44 or the core casing 46.

An inner cowl space 81 is defined between at least a portion of the engine core 44 and the inner cowl 76. More specifically, the inner cowl space 81 is the region or space between the core casing 46 and the inside face 80 of the inner cowl 76.

A nacelle or outer cowl 82 is radially spaced from the inner cowl 76 and can circumscribe at least a portion of the inner cowl 76. The outer cowl 82 has a radially outer surface 84 and a radially inner surface 86, where the radially inner surface 86 confronts the outside face 78 of the inner cowl 76. The radially outer surface 84 and the radially inner surface 86 define an outer cowl space 85. The outer cowl 82 can support or define the fan casing 40.

A strut or a fairing 88 extends radially from the inner cowl 76 to the outer cowl 82. That is, the fairing 88 radially extends or spans a bifurcated airflow path 89 between the inner cowl 76 and outer cowl 82. The fairing 88 is illustrated, by way of example, as located in the compressor section 22. It is contemplated, however, that a portion of the fairing 88 can extend into the fan section 18 or the combustion section 28. Optionally, the fairing 88 is axially located downstream of the fan casing 40 or the outlet guide vane assembly 45. The fairing 88 connects or couples the inner cowl 76 and the outer cowl 82. More specifically, the fairing 88 can couple the inner cowl space 81 with the outer cowl space 85. In other words, the fairing 88 can include a hollow portion 91 extending between the inner cowl 76 and outer cowl 82.

A first accessory gearbox (AGB1) 90 extends from the inner cowl space 81 into the hollow portion 91 of the fairing 88. Optionally, the AGB1 90 can extend from the inner cowl space 81, through the hollow portion 91 of the fairing 88, and into the outer cowl space 85. The AGB1 90 is axially located upstream of the turbine section 32 and downstream of the fan section 18, the LP compressor 24, or the outlet guide vane assembly 45. One or more shafts 92 and one or more gears (not shown) can operably couple the AGB1 90 to the HP spool 48 or the LP spool 50.

A first accessory device 94 is coupled to the AGB1 90. The first accessory device 94 is located radially between the core casing 46 and the inner cowl 76. The first accessory device 94 is located upstream of the combustion section 28 or the turbine section 32. Locating both the first accessory device 94 and the AGB 1 90 upstream of the combustion section 28 or the turbine section 32 provides temperature benefits.

As illustrated, by way of example, the first accessory device 94 is axially downstream of the AGB1 90. Alternatively, it is contemplated that the first accessory device 94 can be radially offset and axially align with at least a portion of the AGB1 90. In yet another different and non-limiting example, the first accessory device 94 can extend or be located upstream of the AGB1 90.

Alternatively, it is further contemplated in a differing and non-limiting example, that the first accessory device 94 can be a set of first accessory devices that can include aircraft accessories, engine accessories, or a combination therein. The set of first accessory devices are located upstream of the combustion section 28 and can be located downstream, upstream, or at least partially axially align with the AGB1 90. For example, the set of first accessory devices can include two accessory devices where one accessory device is located downstream of the AGB1 90 and the other accessory device is axially aligned with the AGB1 90 or is located circumferentially on either side of the AGB1 90.

The first accessory device 94 is illustrated, by way of example, as an aircraft accessory having communication with an aircraft by a communication line 100. The first accessory device 94 or the set of first accessory devices located within the inner cowl space 81 can be, by way of non-limiting example, one or more of a starter, a hydraulic pump, or an electric generator. The electrical generator can be, by way of non-limiting example, a variable frequency generator. The starter, by way of example, can be a pneumatic starter or air turbine starter.

A second accessory device 102 is coupled to the AGB1 90. The second accessory device 102 is located in the hollow portion 91 of the fairing 88. The second accessory device 102 is located upstream of the combustion section 28 or the turbine section 32. Locating both the second accessory device 102 and the AGB1 90 upstream of the combustion section 28 or the turbine section 32 provides temperature benefits.

While illustrated as located in the hollow portion 91 of the fairing, it is contemplated that the second accessory device 102 can be partially located or otherwise extend into the inner cowl space 81.

As illustrated, by way of example, the second accessory device 102 is axially upstream of the AGB1 90. Alternatively, it is contemplated that the second accessory device 102 can extend or be located downstream of the AGB1 90. In yet another different and non-limiting example, the second accessory device 102 can be radially offset and axially align with at least a portion of the AGB1 90.

Alternatively, it is further contemplated in a differing and non-limiting example, that the second accessory device 102 can be a set of second accessory devices that can include aircraft accessories, engine accessories, or a combination therein. The set of second accessory devices are located upstream of the combustion section 28 and can be located downstream, upstream, or at least partially axially align with the AGB1 90. For example, the set of second accessory devices can include two accessory devices where one accessory device is located downstream of the AGB1 90 and the other accessory device is axially aligned with the AGB1 90 or is located circumferentially on either side of the AGB1 90.

The second accessory device 102 or the set of secondary accessory devices can be an aircraft accessory, an engine accessory, or any combination therein. The second accessory device 102 can be by way of non-limiting example, a lubrication pump.

A connection assembly 104 or a transfer gearbox (TGB) operably couples the AGB1 90 to a second accessory gearbox (AGB2) 110. The connection assembly 104 can include a first transfer shaft 112, a first interface 114, a second interface 116, and a second transfer shaft 118. The first transfer shaft 112 can extend radially from the AGB1 90 toward the outer cowl 82. The first transfer shaft 112 can pass through the hollow portion 91 of the fairing 88. In a different and non-limiting example, the connection assembly 104 that operably couples the AGB1 90 to the AGB2 110 can include a series of interlocking gears (not shown). Further, it is contemplated that any number of shafts, gears, or other elements can couple the AGB1 90 to the AGB2 110 to provide a rotational output from the AGB1 90 received as rotational input at the AGB2 110.

Alternatively, in a different and non-limiting example, the AGB1 90 can extend into the outer cowl space 85 and provide a rotational output to the second transfer shaft 118 to drive the AGB2 110.

The AGB2 110 is coupled to the second transfer shaft 118 and receives rotational energy from the second transfer shaft 118. The AGB2 110 is located upstream of the combustion section 28. However, as illustrated by way of example, the AGB2 110 can be located upstream of the HP compressor section 26. That is, the AGB2 110 can be located in the fan section 18, axially adjacent an upstream portion of the LP compressor 24, or combination thereof.

A third accessory device 120 is coupled to the AGB2 110. The third accessory device 120 is located upstream of the combustion section 28. The third accessory device 120 can also be upstream of the fairing 88 or upstream of at least a portion of the outlet guide vane assembly 45. That is, one or more portions of the third accessory device 120 can be located in the fan section 18, axially overlapping an upstream portion of the LP compressor 24, or combination thereof. By way of non-limiting example, the third accessory device 120 can axially overlap the fan casing 70. Having the AGB2 110 or the third accessory device 120 upstream of the combustion section 28 and radially spaced from the engine core 44 provides a cooler environment than a radially or axially location closer to the combustion section 28.

The third accessory device 120 is located in the outer cowl space 85. As illustrated, by way of example, the third accessory device 120 is axially upstream of the AGB2 110. Alternatively, it is contemplated that the third accessory device 120 can be radially offset and axially align with at least a portion of the AGB2 110. In yet another different and non-limiting example, the third accessory device 120 can extend or be located downstream of the AGB2 110. That is, the third accessory device 120 can extend from any one or more portions of the AGB2 110 in any radial, axial, or circumferential arrangement such that the AGB2 110 provides an output to the third accessory device 120 in the outer cowl 82. It is also contemplated that the third accessory device 120 can axially overlap at least a portion of the fan blades 42.

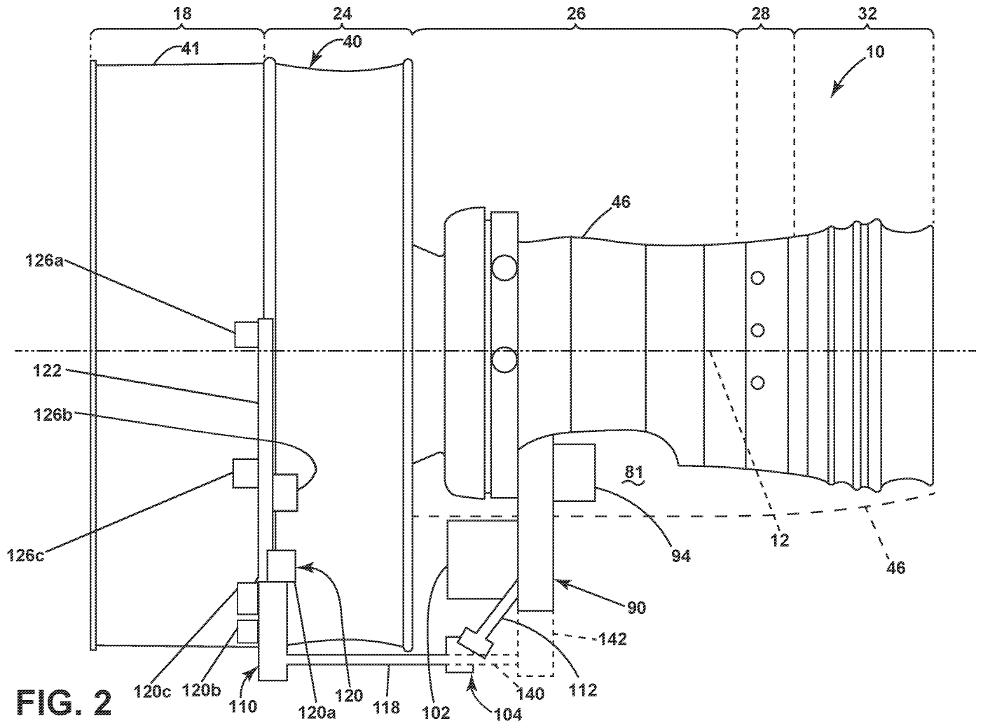

Alternatively, it is further contemplated in a differing and non-limiting example, that the third accessory device 120 can be a set of third accessory devices (see FIG. 2) that can include aircraft accessories, engine accessories, or a combination therein. The set of third accessory devices 120 are located in the outer cowl space 85 upstream of the HP compressor 26 or the combustion section 28 and can be located downstream, upstream, or at least partially axially align with the AGB2 110.

The third accessory device 120 or the set of third accessory devices can include one or more of a fuel pump, scavenge pump, fuel metering device, fuel boost pump, permanent magnet alternator, engine turning motor, or rotisserie.

In operation, air flows through the fan section 18 to an inlet 128 that is defined by the fan assembly 20. Airflow exiting the fan section 18 through the inlet 128 enters a bifurcated airflow path. The bifurcated airflow path includes a first airflow 130 through the engine core 44 and a second airflow 132 through the bifurcated airflow path 89. Therefore, the inlet 128 can be fluidly coupled to the engine core 44 and the bifurcated airflow path 89.

The first airflow 130 is channeled into the LP compressor 24 where it is pressurized (hereinafter referred to as “a pressurized airflow 130”), which then supplies the pressurized airflow 130 to the HP compressor 26, which further pressurizes the pressurized airflow 130. The pressurized airflow 130 from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the turbine engine 10 via the exhaust section 38. The driving of the LP turbine 36 drives the LP spool 50 to rotate the fan assembly 20 and the LP compressor 24.

A portion of the pressurized airflow 130 can be drawn from the compressor section 22 as bleed air 136. The bleed air 136 can be drawn from the pressurized airflow 130 and provided to engine components requiring cooling. The temperature of pressurized airflow 130 entering the combustor 30 is significantly increased. As such, cooling provided by the bleed air 136 is necessary for operating of such engine components in the heightened temperature environments.

The second airflow 132 travels through the bifurcated airflow path 89 (hereinafter, secondary airflow path 89) defined by the inner cowl 76 and the outer cowl 82. That is, the outside face 78 of the inner cowl 76 and the radially inner surface 86 of the outer cowl 82 can define the secondary airflow path 89.

The second airflow 132 bypasses the engine core 44 and exits the turbine engine 10. The secondary airflow path 89 can include a stationary vane row, and more particularly the outlet guide vane assembly 45, that includes a plurality of airfoil guide vanes 138. More specifically, a circumferential row of radially extending airfoil guide vanes 138 are utilized adjacent the fan section 18 to exert some directional control of the second airflow 132.

Some of the air supplied by the fan assembly 20 can bypass the engine core 44 and be used for cooling of portions, especially hot portions, of the turbine engine 10, and/or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid can be, but are not limited to, fluid discharged from the LP compressor 24 or the HP compressor 26.

As the LP spool 50 or the HP spool 48 rotate, rotational energy is provided to the AGB1 90 by the one or more shafts 92. The AGB 1 90 provides rotational output to the first accessory device 94, the second accessory device 102, and the connection assembly 104 or the second transfer shaft 118. The connection assembly 104 or the second transfer shaft 118 then rotates one or more portions of the AGB2 110, which is operably coupled to the third accessory device 120.

FIG. 2 is a schematic side view of the turbine engine 10 wherein the outer cowl 82, the inner cowl 76, and the fairing 88 (FIG. 1) are removed for ease of understanding.

The third accessory device 120 is illustrated as a set of third accessory devices 120a, 120b, 120c, operably coupled to the AGB2 110. While illustrated as having three accessory devices, the set of third accessory devices 120a, 120b, 120c can include any number of accessory devices.

It is contemplated that at least a subset of the set of third accessory devices 120a, 120b, 120c can be mounted to an exterior 41 of the fan casing 40 located at the radially inner surface 86 (FIG. 1) of the outer cowl 82 (FIG. 1). The set of third accessory devices 120a, 120b, 120c can be axially located in one or more of the fan section 18 or the LP compressor 24 (FIG. 1). That is, the set of third accessory devices 120a, 120b, 120c are upstream of the combustion section 28 and the turbine section 32. Further, the set of third accessory devices 120a, 120b, 120c can be upstream of the HP compressor 26.

Connecting accessories, illustrated as connecting accessories 126a, 126b, 126c can be located in the outer cowl space 85 (FIG. 1) on the exterior 41 of the fan casing 40, for example. The connecting accessories 126a, 126b, 126c can couple to one or more of the set of third accessory devices 120a, 120b, 120c. Connecting accessories 126a, 126b, 126c can include, by way of non-limiting example, a fuel filter, heat exchanger, a monitoring device, or a metering device.

Optionally, a coupling mechanism 122 can provide communication, fluid flow, or transfer of power between the one or more of the connecting accessories 126a, 126b, 126c and one or more of the set of third accessory devices 120a, 120b, 120c.

The first accessory device 94, the second accessory device 102, or both the first accessory device 94 and the second accessory device 102 are larger than at least one device of the set of third accessory devices 120a, 120b, 120c. It is contemplated that a volume of the at least one device of the set of third accessory devices 120a, 120b, 120c is in a range of 2% to 66% of a volume of the first accessory device 94, a volume of the second accessory device 102, or a volume of the first accessory device 94 and a volume of the second accessory device 102. More specially, the at least one device of the set of third accessory devices 120a, 120b, 120c is in a range of 2% to 45% of the volume of the first accessory device 94, the volume of the second accessory device 102, or the volume of the first accessory device 94 and the volume of the second accessory device 102.

It is further contemplated that every device of the set of third accessory devices 120a, 120b, 120c is in a range of 1% to 90% of the volume of the first accessory device 94, the volume of the second accessory device 102, or the volume of the first accessory device 94 and the volume of the second accessory device 102.

The AGB1 90 is larger than the AGB2 110. It is contemplated that a volume of the AGB2 is in a range from 10% to 80% of a volume of the AGB1. More specifically, the AGB2 is in a range from 15% to 66% of the volume of the AGB1.

The AGB2 110 is a mini accessory gearbox. As used herein “mini” means that the component referenced with the term mini is smaller than the corresponding like component without the term mini (i.e., the mini accessory gearbox 110 is smaller than the AGB1 90).

The first transfer shaft 112 extending from the AGB1 90 operably couples to the second transfer shaft 118. Optionally, a portion 140 of the second transfer shaft 118 can couple to a portion 142 of the AGB1 90. That is, the AGB1 90 can directly drive the second transfer shaft 118.

While AGB1 90 and AGB2 110 are illustrated as coupled by the first transfer shaft 112, the connection assembly 104, and the second transfer shaft 118, any number of gears or shafts are contemplated to operably couple the AGB2 and the AGB1. That is, it is contemplated that a series of gears can extend from AGB1 to AGB2 to provide AGB2 with rotation energy.

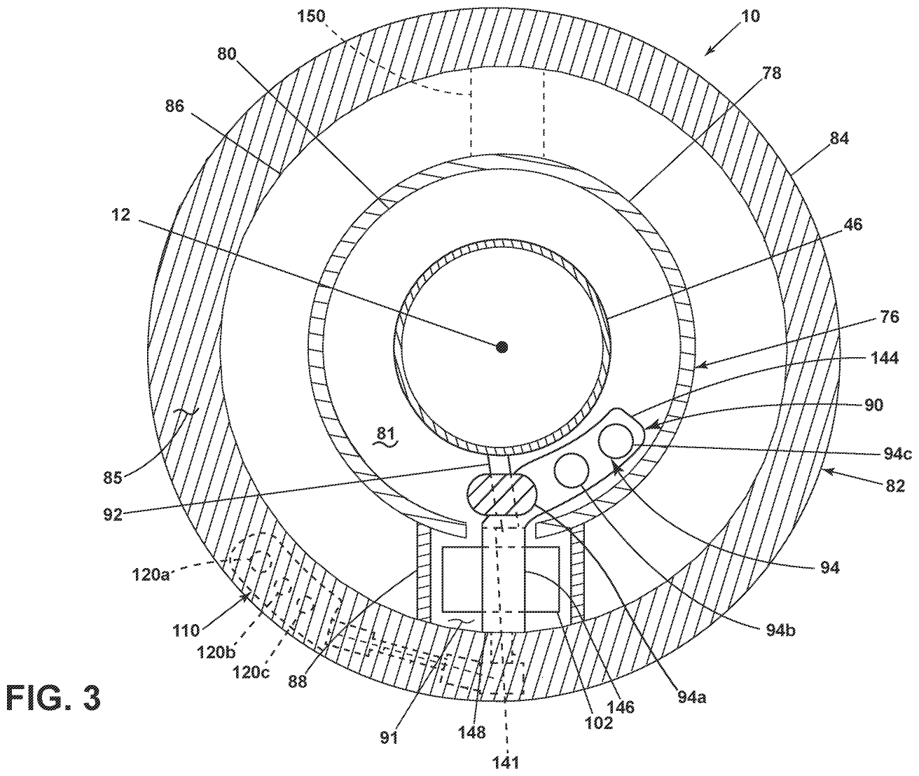

FIG. 3 is a schematic cross-section of the turbine engine 10 taken along the line III-III of FIG. 1. The AGB1 90 includes a first portion 144 and a second portion 146. The first portion 144 of the AGB1 90 is located between the core casing 46 and the inside face 80 of the inner cowl 76. The first portion 144 curves or arcs about the turbine engine axis of rotation 12 or the engine core 44 (FIG. 1) radially outside of the core casing 46.

The second portion 146 of the AGB1 90 extends from the first portion 144 into the fairing 88. While illustrated as having an end 148 located in the hollow portion 91 of the fairing 88, it is contemplated that the end 148 can extend past the radially inner surface 86 of the outer cowl 82.

An intersection 141 or transition can be defined where the second portion 146 extends from the first portion 144. The one or more shafts 92 can couple to the AGB1 90 at or adjacent the intersection 141. The rotational energy provided by the one or more shafts 92 to the AGB 1 90 can be used to drive or operate the first accessory device 94 and the second accessory device 102 by a series of gears or the combination of gears and shafts.

The first accessory device 94 is illustrated as a set of first accessory devices 94a, 94b, 94c. The set of first accessory devices 94a, 94b, 94c are located radially between the core casing 46 and the inside face 80 of the inner cowl 76. The set of first accessory devices 94a, 94b, 94c are operably coupled to the first portion 144 of the AGB1 90.

The set of first accessory devices 94a, 94b, 94c are illustrated, by way of example, as having an oval or circular cross section, however any cross-sectional shape is contemplated. By way of non-limiting example, the first accessory device 94 cross-sectional shape can be rectangular, trapezoidal, regular polygon, irregular polygon, or any combination thereof.

By way of example, the set of first accessory devices 94a, 94b, 94c can include at least one or more of a variable frequency generator, a hydraulic pump, and a starter.

Locating a variable frequency generator in the inner cowl space 81 instead of between the radially outer surface 84 and the radially inner surface 86 of the outer cowl 82, provides the benefit of decreasing drag and improving the aerodynamics of the outer cowl 82. The variable frequency generator is generally a larger accessory and by locating it in the inner cowl space 81 instead of the outer cowl space 85, the inner cowl 76 and the outer cowl 82 can be more streamlined or aerodynamic when the variable frequency generator is within the outer cowl space 85. Having a leaner or more aerodynamic inner cowl 76 and outer cowl 82 can reduce the overall diameter of the turbine engine 10.

Locating the hydraulic pump in the inner cowl space 81 instead of the outer cowl space 85 decreases drag, improves the aerodynamics of the outer cowl 82, and reduces overall weight. When located in the outer cowl space 85, additional tubing is required to provide hydraulic services from the hydraulic pump to the engine core 44 (FIG. 1). By locating the hydraulic pump in the inner cowl space 81, less tubing is needed which provides a weight savings and a material savings.

Locating a starter in the inner cowl space 81 instead of the outer cowl space 85 decreases drag, improves the aerodynamics of the outer cowl 82, and reduces overall weight by minimizing the required air duct length.

The second accessory device 102 operably couples to the second portion 146 of the AGB1 90. The second accessory device 102 can be a lubrication pump. Locating the lubrication pump in the hollow portion 91 of the fairing 88 instead of and outer cowl space 85 decreases drag, improves the aerodynamics of the outer cowl 82, and reduces overall weight by reducing the length of lubrication lines. Further, locating the lubrication pump in the fairing 88 is a cooler environment than the inner cowl space 81. Additional benefits to locating the lubrication pump in the fairing 88 include maintaining or improving the aerodynamics of both the outer cowl 82 and the inner cowl 76.

While illustrated as extending through the fairing 88 at a lower portion of the turbine engine 10, it is contemplated that the AGB1 90 could extend through a different fairing, such as an upper fairing 150.

The set of third accessory devices 120a, 120b, 120c are operably coupled to the mini accessory gearbox (AGB2 110). The set of third accessory devices 120a, 120b, 120c, are smaller than the set of first accessory devices 94a, 94b, 94c and the second accessory device 102. The set of third accessory devices 120a. 120b, 120c can include one or more of a fuel pump, a permanent magnet alternator, or an engine turning motor.

Locating the fuel pump in the outer cowl space 85 provides a cooler environment. Further, locating the fuel pump in the outer cowl space 85 at the fan casing 40 (FIG. 1), allows for easy accessibility. Connecting accessories 126a, 126b, 126c (FIG. 2) can be coupled to the fuel pump and can also be located in the outer cowl space 85 which is a cooler environment.

Locating the permanent magnet alternator in the outer cowl space 85 provides the permanent magnet alternator closer to the full authority digital engine control reducing harness weight. Locating the permanent magnet alternator in the outer cowl space 85 places the permanent magnet alternator in an environment that requires less shielding when compared to the inner cowl space 81. It is also contemplated that the coating on the wires could be thinner when located in the outer cowl space 85 as compared with the inner cowl space 81.

Locating the engine turning motor in the outer cowl space 85 provides the engine turning motor closer to the full authority digital engine control. Locating the engine turning motor closer to the full authority digital engine control reduces harness weight.

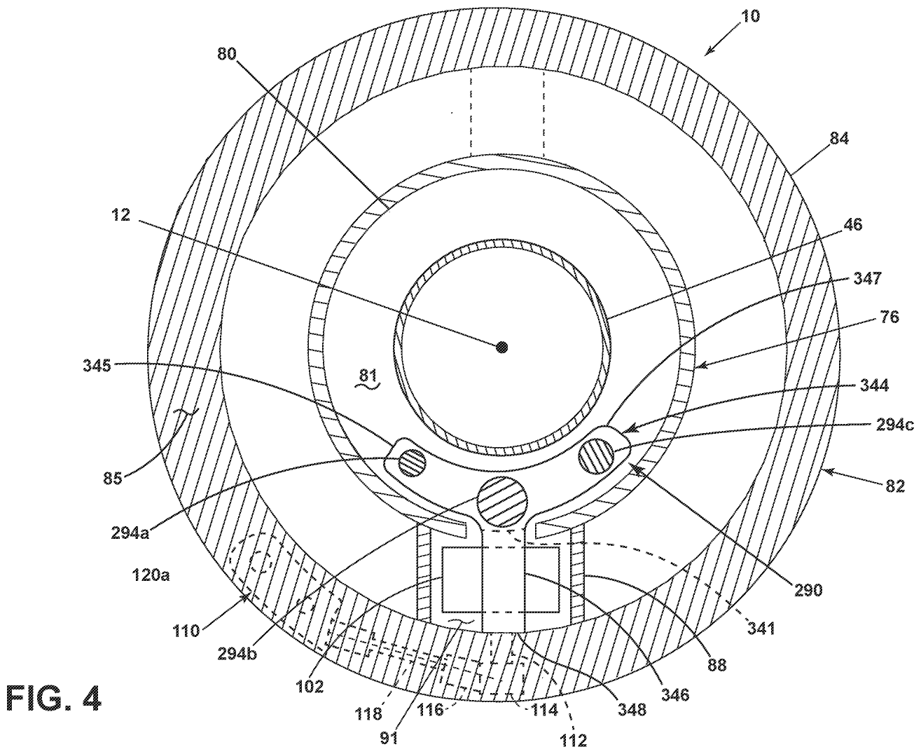

FIG. 4 is a variation of the schematic cross-section of the turbine engine 10 of FIG. 3 illustrating a first accessory gearbox (AGB1) 290. The AGB1 290 is similar to the AGB1 90 (FIG. 1), therefore, like parts of the AGB1 290 will be identified with like numerals increased by 200, with it being understood that the description of the like parts of the AGB1 90 applies to the AGB1 290, except where noted.

The AGB1 290 includes a first portion 344 and a second portion 346. The first portion 344 is located in the inner cowl space 81 that is the region or space between the core casing 46 and the inside face 80 of the inner cowl 76. The first portion 344 includes a first arm 345 and a second arm 347. The first arm 345 and the second arm 347 can straddle or wrap around different portions of the turbine engine axis of rotation 12 or the core casing 46. The first arm 345 and the second arm 347 can form a U-shape, as illustrated. However, it is contemplated that the first arm 345 and the second arm 347 can form a V-shape. It is contemplated that the first arm and the second arm straddle the engine core.

While illustrated as symmetric, it is contemplated that the first arm 345 and the second arm 347 extend different arc-lengths about the core casing 46.

The second portion 346 extends from the first portion 344 at an intersection 341. While illustrated as in the inner cowl space 81, it is contemplated that the intersection 341 can be in the hollow portion 91 of the fairing 88.

A set of first accessory devices 294a, 294b, 294c can couple to one or more portions of the first arm 345 or the second arm 347. As illustrated, by way of example, the set of first accessory devices 294a, 294b, 294c can include at least one device 294b located at the intersection of the first arm 345 and the second arm 347. While illustrated as coupling to the first portion 344 at the inner cowl space 81, it is contemplated that one or more portions of one of more of the set of first accessory devices 294a, 294b, 294c can extend into the hollow portion 91 of the fairing 88.

The second accessory device 102 operably couples to the second portion 346 of the AGB1 290. While illustrated as coupling to the second portion 346 at the hollow portion 91 of the fairing 88, it is contemplated that one or more portions of one of more of the second accessory device 102 can extend into the inner cowl space 81 or the outer cowl space 85.

An end 348 of the second portion 346 can couple to the first transfer shaft 112 which transfers rotational energy from the AGB1 290 to the AGB2 110 by way of the first interface 114, the second interface 116, and the second transfer shaft 118. However, it is contemplated, in a different and non-limiting example, that the end 348 of the AGB1 290 can extend into the outer cowl space 85. Further, it is contemplated in another different and non-limiting example that the transfer of energy from the AGB1 290 to the AGB2 110 can be completed using any number of shafts, transfer gearboxes, connecting interfaces, or gears.

Benefits of aspects of the disclosure include improved overall fuel efficiency. The unique design reflects a desirable trade between the benefit of overall fuel efficiency verses the penalties of electing to use two gearboxes. That is, using two gearboxes, where the primary gearbox is located in the inner cowl space and the hollow portion of the fairing and the mini gearbox is located in the outer cowl space, along with placing larger accessories in the inner cowl space or the hollow portion of the fairing with smaller accessories located in the outer cowl provides the unexpected solution of improved overall fuel efficiency.

Benefits of locating the first accessory device (or the set of first accessory devices) and the second accessory device within the inner cowl and fairing (instead of in the outer cowl) reduces the length of the communication lines, fluid lines, or other connecting components to aircraft systems or the engine core. Shortening the communication lines, fluid lines, or other connecting components can reduce weight carried by the aircraft. Further, shortening the communication lines, fluid lines, or other connecting components will have a material savings.

Benefits of locating the first accessory device (or the set of first accessory devices) and the second accessory device within the inner cowl space and fairing (instead of in the outer cowl space) improves aerodynamics and weight of the outer cowl and the inner cowl. A thinner, lighter outer cowl can be used and therefore provides a weight savings. Further, the aerodynamics of the outer cowl and/or the inner cowl can be improved. That is, the inner and outer cowls can be smaller and/or more streamlined or aerodynamic when the first accessory device (or the set of first accessory devices) and the second accessory device are within the inner cowl and fairing instead of in the outer cowl. The improved airflow through the cowls and improved aerodynamic lines improves fuel efficiency.

Further, the unique location of the first, second, and third accessories can provide for a slim line nacelle fan cowl.

The split configuration of the accessories provides a maintenance advantage. That is, not placing the first, second, and third accessories all in the inner cowl space makes it easier to access each accessory. As compared to a fully core AGB with accessories, the split configuration reduces the number (or density) of accessories in the inner core space; which can make it easier to provide maintenance to the first accessory or set of first accessories. Further, the hollow portion of the fairing as well as the outer cowl space are known to be accessible spaces to provide maintenance. Therefore, maintenance to the second accessory and the third accessory or third set of accessories is improved when compared to a fully core AGB with accessories.

The configuration of the mini AGB with select accessories in the outer cowl provides a cooler environment for the operation of the mini AGB and attached accessories. While the inner cowl and fairing are a warmer environment, a temperature benefit can still be had by locating the AGB1 and attached accessories upstream of the combustion section.

Therefore, aspects of the disclosure simultaneously improve fuel burn by facilitating a tight aerodynamic cowl line package around the engine core and fan while balancing environment temperature and maintenance access.

Further aspects of the disclosure are provided by the subject matter of the following clauses:

A turbine engine comprising a fan section, a compressor section, a combustion section, and a turbine section in axial flow arrangement and defining a turbine engine axis of rotation, wherein the compressor section comprises a low-pressure compressor and a high-pressure compressor, an engine core defined by the compressor section, the combustion section, and the turbine section, an inner cowl circumscribing at least a portion of the engine core and radially spaced from the engine core to define an inner cowl space, an outer cowl circumscribing at least a portion of the inner cowl and spaced from the inner cowl, wherein the outer cowl includes a radially outer surface spaced from a radially inner surface to define an outer cowl space, a fairing extending radially between the inner cowl and the outer cowl having at least a hollow portion, a first accessory gearbox having a first portion located in the inner cowl space and a second portion, extending from the first portion, located in the hollow portion of the fairing, a first accessory device located in the inner cowl space and operably coupled to the first portion of the first accessory gearbox, a second accessory device located in the hollow portion of the fairing and operably coupled to the second portion of the first accessory gearbox, a second accessory gearbox located in the outer cowl space and operably coupled to the first accessory gearbox, and a third accessory device operably coupled to the second accessory gearbox and located in the outer cowl space.

A turbine engine comprising a fan section, a compressor section, a combustion section, and a turbine section in axial flow arrangement and defining a turbine engine axis of rotation, wherein the compressor section comprises a low-pressure compressor and a high-pressure compressor, an engine core defined by the compressor section, the combustion section, and the turbine section, an inner cowl circumscribing at least a portion of the engine core and radially spaced from the engine core to define an inner cowl space, an outer cowl circumscribing at least a portion of the inner cowl and spaced from the inner cowl, wherein the outer cowl includes a radially outer surface spaced from a radially inner surface to define an outer cowl space, a fairing extending radially between the inner cowl and the outer cowl having at least a hollow portion, a first accessory gearbox having a first portion located in the inner cowl space and a second portion, extending from the first portion, located in the hollow portion of the fairing, at least two accessories, wherein the at least two accessories are two of an electrical generator, a starter, or a pump operably coupled to the first accessory gearbox, wherein at least one of the at least two accessories is located at least partially in the inner cowl space and the other of the at least two accessories is located at least partially in the hollow portion of the fairing, a second accessory gearbox located in the outer cowl space and operably coupled to the first accessory gearbox, and a third accessory device operably coupled to the second accessory gearbox and located in the outer cowl space.

The turbine engine of any preceding clause, wherein the first accessory device includes at least one of a variable frequency generator, a hydraulic pump, and a starter.

The turbine engine of any preceding clause, wherein the second accessory device is a lubrication pump.

The turbine engine of any of the preceding clauses, wherein the third accessory device is one or more of a fuel pump, a permanent magnet alternator, or an engine turning motor.

The turbine engine of any preceding clause, wherein the second accessory device is a lubrication pump and the third accessory device is a fuel pump, a permanent magnet alternator, or an engine turning motor.

The turbine engine of any preceding clause, wherein the second accessory gearbox is a mini accessory gearbox.

The turbine engine of any preceding clause, wherein the mini accessory gearbox is located forward of the first accessory gearbox.

The turbine engine of any preceding clause, wherein the third accessory device coupled to the mini accessory gearbox is a fuel pump, a permanent magnet alternator, or an engine turning motor.

The turbine engine of any preceding clause, wherein a volume of the mini accessory gearbox is in a range from 10% to 80% of a volume of the first accessory gearbox.

The turbine engine of any preceding clause, wherein a volume of the mini accessory gearbox is in a range from 15% to 66% of a volume of the first accessory gearbox.

The turbine engine of any preceding clause, wherein a volume of the third accessory device is in a range of 2% to 66% of a volume of the first accessory device or the second accessory device 102.

The turbine engine of any preceding clause, wherein a volume of the third accessory device is in a range of 2% to 45% of a volume of the first accessory device or the second accessory device 102.

The turbine engine of any preceding clause, wherein the third accessory device is a set of third accessory devices, where each device of the set of third accessory devices has a volume in a range of 2% to 66% of a volume of the first accessory device or the second accessory device 102.

The turbine engine of any preceding clause, further comprising at least one shaft operably coupling the first accessory gearbox to the second accessory gearbox.

The turbine engine of any preceding clause, further comprising one or more shafts coupling the engine core to the first accessory gearbox.

The turbine engine of any preceding clause, wherein the one or more shafts couple the engine core to the first accessory gearbox at an intersection of the first portion and the second portion.

The turbine engine of any preceding clause, wherein the second portion of the first accessory gearbox extends from the first portion in the inner cowl space, through the hollow portion of the fairing, and into the outer cowl space.

The turbine engine of any preceding clause, further comprising at least one shaft located at least partially in the outer cowl operably coupling the first accessory gearbox to the second accessory gearbox.

The turbine engine of any preceding clause, wherein the first portion of the first accessory gearbox includes a first arm and a second arm that straddle the engine core.

The turbine engine of any preceding clause, wherein the second accessory gearbox is axially located in the fan section or radially outward of the low-pressure compressor.

The turbine engine of any preceding clause, wherein the fan section includes fan blades rotatable about the turbine engine axis of rotation and circumscribed by a fan casing defined, in part, by the outer cowl, wherein the second accessory gearbox and the third accessory device are coupled to an exterior of the fan casing.

The turbine engine of any preceding clause, wherein the third accessory device axially overlaps the fan casing.

The turbine engine of any preceding clause, wherein the first accessory device is located forward of the combustion section.

The turbine engine of any preceding clause, wherein the second accessory device is located forward of the combustion section.

1. (canceled)

2. The turbine engine of claim 21, wherein the first accessory device includes at least one of a variable frequency generator, a hydraulic pump, and a starter.

3. The turbine engine of claim 21, wherein the second accessory device is a lubrication pump.

4. (canceled)

5. (canceled)

6. The turbine engine of claim 21, wherein the second accessory gearbox is a mini accessory gearbox.

7. The turbine engine of claim 6, wherein the mini accessory gearbox is located forward of the first accessory gearbox.

8. The turbine engine of claim 6, wherein the third accessory device coupled to the mini accessory gearbox is a fuel pump, a permanent magnet alternator, or an engine turning motor.

9. The turbine engine of claim 6, wherein a volume of the mini accessory gearbox is in a range from 10% to 80% of a volume of the first accessory gearbox.

10. The turbine engine of claim 21, wherein a volume of the third accessory device is in a range of 2% to 66% of a volume of the first accessory device or the second accessory device 102.

11. The turbine engine of claim 21, further comprising at least one shaft operably coupling the first accessory gearbox to the second accessory gearbox.

12. The turbine engine of claim 21, further comprising one or more shafts coupling the engine core to the first accessory gearbox.

13. The turbine engine of claim 21, wherein the second portion of the first accessory gearbox extends from the first portion in the inner cowl space, through the hollow portion of the fairing, and into the outer cowl space.

14. The turbine engine of claim 13, further comprising at least one shaft located at least partially in the outer cowl operably coupling the first accessory gearbox to the second accessory gearbox.

15. The turbine engine of claim 21, wherein the first portion of the first accessory gearbox includes a first arm and a second arm that straddle the engine core.

16. The turbine engine of claim 21, wherein the second accessory gearbox is axially located in the fan section or radially outward of the low-pressure compressor.

17. The turbine engine of claim 21, wherein the fan section includes fan blades rotatable about the turbine engine axis of rotation and circumscribed by a fan casing defined, in part, by the outer cowl, wherein the second accessory gearbox and the third accessory device are coupled to an exterior of the fan casing.

18. The turbine engine of claim 17, wherein the third accessory device axially overlaps the fan casing.

19. The turbine engine of claim 21, wherein the first accessory device is located forward of the combustion section.

20. The turbine engine of claim 19, wherein the second accessory device is located forward of the combustion section.

21. A turbine engine comprising:
a fan section, a compressor section, a combustion section, and a turbine section in axial flow arrangement and defining a turbine engine axis of rotation, wherein the compressor section comprises a low-pressure compressor and a high-pressure compressor;
an engine core defined by the compressor section, the combustion section, and the turbine section;
an inner cowl circumscribing at least a portion of the engine core and radially spaced from the engine core to define an inner cowl space;
an outer cowl circumscribing at least a portion of the inner cowl and spaced from the inner cowl, wherein the outer cowl includes a radially outer surface spaced from a radially inner surface to define an outer cowl space;
a fairing extending radially between the inner cowl and the outer cowl having at least a hollow portion;
a first accessory gearbox comprising:
a first portion located in the inner cowl space;
a second portion, extending from the first portion, located in the hollow portion of the fairing; and
an intersection defined where the second portion extends from the first portion, wherein the first portion arcs in a single direction from the intersection about the turbine engine axis of rotation to define a single arc about a portion the turbine engine axis of rotation;
a first accessory device located in the inner cowl space and operably coupled to the first portion of the first accessory gearbox;
a second accessory device located in the hollow portion of the fairing and operably coupled to the second portion of the first accessory gearbox;
a second accessory gearbox located in the outer cowl space and operably coupled to the first accessory gearbox by a connection assembly comprising at least a first transfer shaft extending from the second portion of the first accessory gearbox toward the outer cowl, wherein the first transfer shaft passes through a portion of the hollow portion of the fairing; and
a third accessory device operably coupled to the second accessory gearbox and located in the outer cowl space.

22. The turbine engine of claim 21, wherein the set of third accessory devices further includes one or more of a fuel pump or a permanent magnet alternator.

23. The turbine engine of claim 21, wherein the first accessory device is a set of first accessory devices, wherein one or more portions of one or more of the set of first accessory devices extends into the hollow portion of the fairing.
